(19) United States
(12) Patent Application Publication
(10) Pub. No.: US 2020/0213874 A1
(43) Pub. Date: Jul. 2, 2020

(54) SYSTEM AND METHOD FOR APPLYING OPERATIBILITY EXPERIENCES ACROSS DIFFERENT INFORMATION DOMAINS

(71) Applicant: Nokia Solutions and Networks Oy, Espoo (FI)

(72) Inventors: Haitao Tang, Espoo (FI); Vilho llmari Raisanen, Espoo (FI)

(21) Appl. No.: 16/486,115

(22) PCT Filed: Feb. 20, 2017
(86) PCT No.: PCT/EP2017/053732

§ 371 Date: Aug. 14, 2019

(51) Int. Cl. H04W 24/02; H04L 12/24

(52) U.S. Cl. CPC H04W 24/02; H04L 41/0853; H04L 41/0681; H04L 41/0823

(57) ABSTRACT

A process for applying operability experiences across different information domains includes receiving an event trigger for a first information domain specific to a first communications technology, searching stored experience data for an experience that matches network data associated with the event trigger in the first information domain, when no similar experiences are found in the first information domain, generating a similarity measure for the second information domain using mapping data that maps parameters of one or more managed object in the first information domain to parameters of the one or more managed object in the second information domain, determining at least one operational experience that matches the similarity measure for the second information domain, and responding to the event trigger with at least one conclusion based on the at least one operational experience.

### BACKGROUND

Multi-Radio Access Technology (RAT), multi-access, and multi-vendor network environments have added significant complexity to network operations. Self-x functions such as SON and traffic steering functions have become an essential part of 3˜4G networks. These self-x functions have reduced the amount of work that would otherwise be needed for 3˜4G networks using fixed rule sets, which effectively reduces the operational complexity perceived by human operators as well. Subsequent network systems such as 5G systems are expected to have a much wider scope, and a larger number and variety of self-x functions and multi-x network environments. In addition, one of the goals of 5G is to minimize the amount of human involvement in network operations.

Future network technologies such as 5G can implement adaptive automation, which may use cognitive architecture supporting information and knowledge sharing. Implementing cognitive elements into cellular networks is a complex endeavor. Cell networks generate large amounts of data related to operations, and that data is stored in and processed by a large variety of hardware that are typically dedicated to specific limited purposes.

Implementing a cognitive system presents a number of challenges. A conventional cognitive system does not have experiences to draw from when it is first initiated, so it is not effective until it has run for some time. Without experiences, a newly implemented cognitive system can degrade network performance in the course of building a set of experiences. Because of the enormous amount of variables that affect network performance, every network installation is effectively unique, so seeding cognitive systems with generic or simulated experiences is a sub-optimal solution.

Finding an optimal solution to a problem in a network benefits from an analysis of related historical data. Finding relevant data by mining the disparate sources in a conventional network requires a great deal of information processing and time, and relevant data may not be stored by conventional systems.

### FIELD OF TECHNOLOGY

Embodiments of the present disclosure are directed to a system and method for a wireless telecommunications network. In particular, embodiments are directed to elements of a cognitive network and cognitive network processes.

### BRIEF SUMMARY

According to an embodiment of the present disclosure, a process for a wireless communications network includes receiving an event trigger for a first information domain specific to a first communications technology, searching stored experience data for an experience that matches network data associated with the event trigger in the first information domain, when no similar experiences are found in the first information domain, generating a similarity measure for the second information domain using mapping data that maps parameters of one or more managed object in the first information domain to parameters of the one or more managed object in the second information domain, determining at least one operational experience that matches the similarity measure for the second information domain, and responding to the event trigger with at least one conclusion based on the at least one operational experience.

The at least one conclusion may be an action for the first domain. For example, the action may be chosen from adjusting a transmit power of a cell, adjusting an azimuth of a cell antenna, adjusting a cell selection parameter, and adjusting a cell reselection parameter. One or more cell may perform the action. In addition, the first domain may be 5G, and the second domain may be GSM, UMTS or LTE.

In an embodiment, the process includes, before determining the at least one conclusion in the first information domain, determining at least one conclusion in the second information domain, and comparing the at least one conclusion in the second information domain to second mapping data that maps conclusions in the second information domain to conclusions in the first information domain, wherein the at least one conclusion in the first domain is a result of the comparing.

The similarity measure may include at least one attribute that is specific to a network management function and a list of manage objects (MOs) on which the network management function is to be executed. The event trigger may be an action request that includes a network performance objective, where the conclusion indicates a change to a network parameter to achieve the network performance objective. The operations of receiving a trigger, searching experience data, determining at least one matching experience and responding to the trigger may be performed by one or more cognitive computing entity in an Operations Support System (OSS) layer of a cellular network. In particular, these operations may be performed by one or more processor included in one or more cognitive computing entity in an Operations Support System (OSS) layer of a cellular network.

### BRIEF DESCRIPTION OF THE DRAWINGS

FIG. 1 illustrates a wireless communications system.

FIG. 2 illustrates a network computing entity of a communications system.

FIG. 3 illustrates an embodiment of communication between network elements in a cognitive communications network.

FIG. 4 illustrates an embodiment of a process for finding a best matching function and corresponding experience cases to achieve an operator's objective.

FIG. 5 illustrates an embodiment of self-operation in cognitive agent architecture.

FIG. 6 illustrates an embodiment of a process for applying self-operation in multiple information domains

FIG. 7 illustrates an embodiment of a process for applying self-operation in multiple information domains.

FIG. 8 illustrates an embodiment of a self-operation process.

### DETAILED DESCRIPTION

A detailed description of embodiments is provided below along with accompanying figures. The scope of this disclosure is limited only by the claims and encompasses numerous alternatives, modifications and equivalents. Although steps of various processes are presented in a particular order, embodiments are not necessarily limited to being performed in the listed order. In some embodiments, certain operations may be performed simultaneously, in an order other than the described order, or not performed at all.

Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure has not been described in detail so that the disclosure is not unnecessarily obscured.

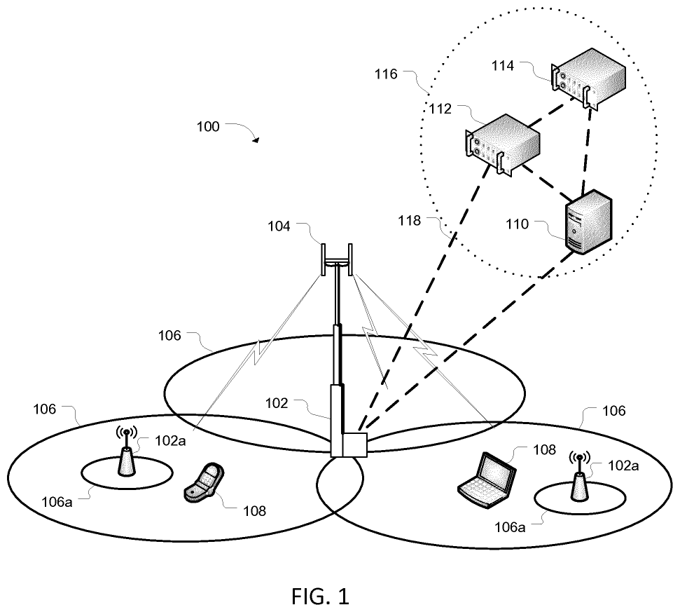

FIG. 1 illustrates a networked communications system 100 according to an embodiment of this disclosure. System 100 includes a plurality of base stations 102, each of which are equipped with one or more antennas 104. Each of the antennas 104 may provide wireless communication for user equipment (UE) 108 in one or more cells 106. Base stations 102 have antennas 104 that are receive antennas which may be referred to as receivers, and transmit antennas, which may be referred to as transmitters.

As used herein, the term “base station” refers to a wireless communications station provided in a location and serves as a hub of a wireless network. For example, in LTE, a base station 102 may be an eNodeB. The base stations may provide service for macrocells, microcells, picocells, or femtocells.

FIG. 1 shows base stations 102a that provide service to small cells 106a that are within a coverage area of macro cells 106. In actual cellular deployments, a plurality of base stations 102a may be located within a cell 106 of a macro cell base station 102. As a result, coverage of one macro-cell 106 may overlap with a plurality of small cells 106a.

The one or more UE 108 may include cell phone devices, mobile hotspots, laptop computers, handheld gaming units, electronic book devices and tablet PCs, and any other type of common portable wireless computing device that may be provided with wireless communications service by a base station 102. In an embodiment, any of the UE 108 may be associated with any combination of common mobile computing devices (e.g., laptop computers, tablet computers, cellular phones, mobile hotspots, handheld gaming units, electronic book devices, personal music players, video recorders, etc.), having wireless communications capabilities employing any common wireless data communications technology, including, but not limited to: GSM, UMTS, 3GPP LTE, LTE Advanced, WiMAX, etc.

The system 100 may include a backhaul portion 116 that can facilitate distributed network communications between backhaul equipment or network controller devices 110, 112 and 114 and the one or more base station 102. As would be understood by those skilled in the art, in most digital communications networks, the backhaul portion 116 of the network may include intermediate links 118 between a backbone of the network which are generally wire line, and sub networks or base stations located at the periphery of the network. For example, cellular mobile devices (e.g., UE 108) communicating with one or more base station 102 may constitute a local sub network. The network connection between any of the base stations 102 and the rest of the world may initiate with a link to the backhaul portion of a provider's communications network (e.g., via a point of presence).

In an embodiment, the backhaul portion 116 of the system 100 of FIG. 1 may employ any of the following common communications technologies: optical fiber, coaxial cable, twisted pair cable, Ethernet cable, and power-line cable, along with any other wireless communication technology known in the art. In context with various embodiments, it should be understood that wireless communications coverage associated with various data communication technologies (e.g., base station 102) typically vary between different service provider networks based on the type of network and the system infrastructure deployed within a particular region of a network (e.g., differences between GSM, UMTS, LTE, LTE Advanced, and WiMAX based networks and the technologies deployed in each network type).

Any of the network controller devices 110, 112 and 114 may be a dedicated Network Resource Controller (NRC) that is provided separately from the base stations or provided at the base station. Any of the network controller devices 110, 112 and 114 may be a non-dedicated device that provides NRC functionality. In another embodiment, an NRC is a Self-Organizing Network (SON) server. In an embodiment, any of the network controller devices 110, 112 and 114 and/or one or more base stations 102 may function independently or collaboratively to implement processes associated with various embodiments of the present disclosure.

In accordance with a standard GSM network, any of the network controller devices 110, 112 and 114 (which may be NRC devices or other devices optionally having NRC functionality) may be associated with a base station controller (BSC), a mobile switching center (MSC), a data scheduler, or any other common service provider control device known in the art, such as a radio resource manager (RRM). In accordance with a standard UMTS network, any of the network controller devices 110, 112 and 114 (optionally having NRC functionality) may be associated with a RNC, a serving GPRS support node (SGSN), or any other common network controller device known in the art, such as an RRM. In accordance with a standard LTE network, any of the network controller devices 110, 112 and 114 (optionally having NRC functionality) may be associated with an eNodeB base station, a mobility management entity (MME), or any other common network controller device known in the art, such as an RRM.

In an embodiment, any of the network controller devices 110, 112 and 114, the base stations 102, as well as any of the UE 108 may be configured to run any well-known operating system. Any of the network controller devices 110, 112 and 114 or any of the base stations 102 may employ any number of common server, desktop, laptop, and personal computing devices.

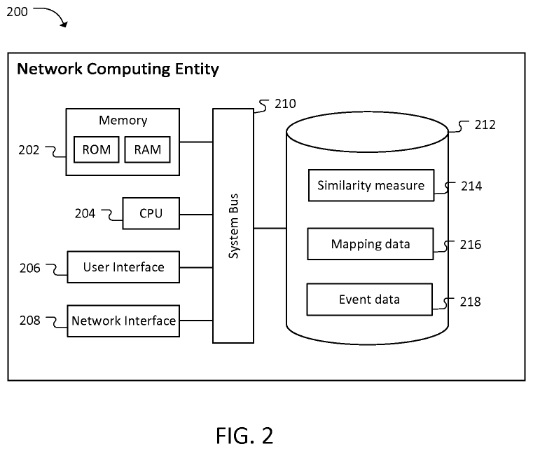

FIG. 2 illustrates a block diagram of a computing entity 200 that may be representative of any of the network controller devices 110, 112 and 114. Accordingly, computing entity 200 may be representative of a Network Management Server (NMS), an Element Management Server (EMS), a Mobility Management Entity (MME), a SON server, a self-operation server, etc. The computing entity 200 has one or more processor devices including a CPU 204. Although a single CPU is shown, the computing entity 200 may include a plurality of CPUs, each of which may include a plurality of processing cores operative to perform processes described in this disclosure.

The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. Storage device 212 may store, for example, similarity measure 214, mapping data 216, and event data 218.

The computing entity 200 may also include a user interface 206 that allows an administrator to interact with the NRC's software and hardware resources and to display the performance and operation of the system 100. In addition, the computing entity 200 may include a network interface 208 for communicating with other components in the networked computer system, and a system bus 210 that facilitates data communications between the hardware resources of the computing entity 200.

In addition to the network controller devices 110, 112 and 114, the computing entity 200 may be used to implement other types of computer devices, such as an antenna controller, an RF planning engine, a core network element, a database system, or the like. Based on the functionality provided by computing entity 200, the storage device of such a computer serves as a repository for software and database thereto. In embodiments of the present disclosure, the computing entity 200 represents computing entities that perform processes described herein, including a validated dissemination entity and a self-operation entity. In various embodiments, these entities may be combined in a single hardware enclosure, or distributed among multiple hardware enclosures at various locations.

### Self-Operation in Wireless Networks

A self-operation system in a cognitive network can substantially increase automation and performance of communications networks. In such systems, relevant past experiences can be used to predict the future status of a network. The corresponding decisions may thus be made to improve either network performance or subscriber perceived experience.

In automated systems, the role of human operators can be seamlessly integrated to observe systems and instruct them when system components have no knowledge to deal with certain situations, or are otherwise incapable of drawing conclusions or making decisions autonomously based on predefined logic. Such systems can prevent functions, self-x or not, of the systems from executing operations that may cause, or are known to have caused, degradation of network performance metrics or unfavorable user experiences. Such systems can also make an operation favorable if its execution is expected to induce improvement in network performance or customer experience.

A self-operation system and process implements cognitive network functionality that can automatically improve network performance and user experience. In a self-operation system, a self-operation case can be created for relevant events, and the system learns every corresponding operation and outcome of the system and stores the learned experiences to the self-operation case. The outcome can be measured by effects on the performance metrics and customer experience, etc. The self-operation case may also store learned context data such as system conditions and other relevant circumstances (e.g. cell configuration, location, and traffic profile) that may have impacted triggering an event.

Data relevant to a corresponding operation may be learned and collected in data elements associated with a self-operation case, and thus may be linked to a piece of useful corresponding experience, which can be applied on the fly. The availability of such experience can be useful.

Conventionally, a very limited amount of data related to experiences are scattered and distributed in a system. Various data elements are stored in different locations, while many data elements are not stored at all. Therefore, data mining of conventional systems has limited utility for identifying relevant experiences. In addition, data mining consumes a large amount of time and resources, so conventional systems and processes cannot satisfy a request for such experience in timely fashion.

An embodiment of a self-operation system may define a similarity measure to find corresponding operation experiences from a potentially large number of learned, but different, self-operation cases. The similarity measure may be a component of self-operability that is specific to a given use case of self-operation. The similarity measure may determine whether the operation experience case, or knowledge, learned from earlier executed operations can be applied to future operations of a given use case.

In an example of self-operation, an operator requests guidance from a self-operation system on how to achieve given objective(s) for network performance or service in a certain area. The objectives of such a request may be related to improvement of certain Key Performance Indicators (KPI) regarding, for example coverage, traffic, mobility, or quality. However, different functions may cause impacts on two or more KPIs at the same time. It is thus difficult for an operator to select a best function out of several candidate functions to achieve an objective.

A similarity measure may be useful to operators in such a situation. Relevant self-operation cases can be matched from a knowledge database of the self-operation system, along with a corresponding objective-specific similarity measure. Information about a best suitable function can then be extracted from relevant self-operation cases.

In another example of self-operation, an operator can have difficulty determining an optimum suitable configuration, such as a SON function Configuration parameter Value for the selected function to achieve a result corresponding to an objective. The suitable configuration of the function may depend on corresponding conditions, such as network configurations, status, traffic, etc., of the managed objects (MOs) where the function is planned to be executed.

A similarity measure may improve such a process. For example, relevant self-operation cases can be matched with a corresponding function-specific similarity measure. Information of an optimum suitable function configuration can then be extracted from the relevant self-operation cases.

A function-specific similarity measure could also be used to find corresponding operation experience cases and extract data for another related major use case of self-operation that addresses whether or not an action request for the function can be executed. Thus, the function-specific similarity measure may enable the operation to select the corresponding configuration for the chosen function, and enable the determination of an action of the function.

In an embodiment, a self-operation case may include data for one or more of context, event, action, result, and profile, and a group ID. The context data may be a set of elements of the network and its OSS that influence the event and action. The elements may include managed objects as well as information elements and parameters. The event data may be data for an occurrence in the network that happened under the context. The action may be an event-triggered execution to the network under the context. The result may be a conclusion on the action, where the conclusion can be made by a function, e.g. a verification function in the OSS or a network function, or by a human operator. An example of a result is an improvement of a KPI.

The profile may be the analytic consequence of the relation between the elements of a reduced self-operation case tuple of context, event, action, and result. The profile may be produced by analyzing the context, action, and result as well as their histories. In an embodiment, a profile is a likelihood of success expressed as a percentage. The group ID may be used to associate common self-operation cases.

For example, when an event is an indication that a rate of Radio Link Failure (RLF) exceeds a threshold value, a corresponding action may be to configure and activate a CCO function instance to optimize one or more cells that relate to an event.

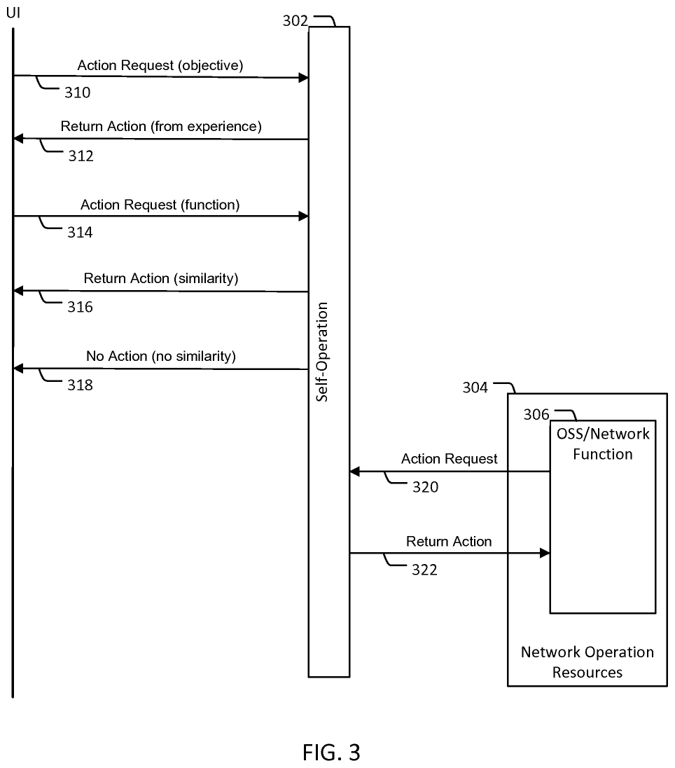

FIG. 3 shows an embodiment of communication between network elements in a cognitive communications network. In FIG. 3, an operator inputs a request 310 for recommended actions to achieve a particular objective into a UI, and that request is transmitted to self-operation server 302. The objective may be a network performance objective such as improved coverage in a particular area, or a user experience objective such as a QoS goal. The objective may be for a general improvement, and the objective may specify one or more value for a parameter that the operator hopes to achieve.

When the self-operation server receives the action request 310, it determines various data that can achieve the objective by analyzing a plurality of experiences. The self-operation server 302 may then return one or more recommended action 312 to the UI that can achieve the objective based on the plurality of experiences. The UI may present the action 312 to an operator for verification.

The UI may transmit an action request 314 to self-operation server 302 based on a function, and receive a recommended action 316 from the server based on a similarity measure. In addition, FIG. 3 shows the case where no matching action was determined by the self-operation server 302, for which the self-operation server notifies the UI at 318.

An OSS or other network function 306 run by network resources 304 may transmit an action request 320 to self-operation server 302, and receive response 322 with a recommended action. The network function 306 may transmit the request 322 and implement the action automatically.

Each of the requests 310, 314 and 320 prompt a similarity measure action by the self-operation server 302. In an embodiment, these messages serve as the triggers to define relevant similarity measures that are used to find the matching self-operation cases with the principle of case based reasoning. The corresponding experiences in the matching self-operation cases (when available) are replied back to the requesting entities.

In an embodiment, there are different types of similarity measures, which may be specific to their actual applications, or use cases. The similarity measures may be used by the self-operation server 302 to find the exactly matching, or similar, self-operation cases (if any) stored in the database of the self-operation entity.

The operational objectives and rules of a network are typically defined with a set of high level KPIs, e.g. KPIs defined in 3GPP TS32.450, for network operations. When an operator wants to achieve a specific objective for network performance under certain rules (e.g., constrains and options), the operator transmits a request 310 to the self-operation server 302. This message may carry the information of the operation objective including the target scope of the targeted MOs, an allowed result, and rules. The rules can be created either by the system vendor or by the operator via means of rule editor, which is a specialized tool for the creation and maintenance of the rules.

The self-operation server 302 uses the received information 310 to define a corresponding objective-specific similarity measure, which may be in the form of a text string carrying the provided information elements. The self-operation server 302 uses the objective-specific measure to find all matching operation experience cases and their functions.

For demonstration purposes, consider an example of a network that uses two Capacity and Coverage Optimization (CCO) functions: CCO-SURROUNDED, which optimizes a cell surrounded by its first-tier neighbor cells, and CCO-HOTSPOT, which optimizes a hotspot source cell. In an example, these functions have caused similar operation experiences in areas containing both surrounded and hotspot cells in the past.

When the self-operation server receives an action request 310, it selects the best suitable experience cases from all the matching operation experience cases. In the example, CCO-SURROUNDED is the function that has achieved the optimization objective in most of the matching cases. The CCO-SURROUNDED function is thus selected automatically as the best suitable function to achieve the intended operation.

The decision for the selection can be made based on several different criteria, such as the highest probability to achieve successful results, operation priorities, or an operator's preferences and policies. The criteria may be defined by rules provided by the operator.

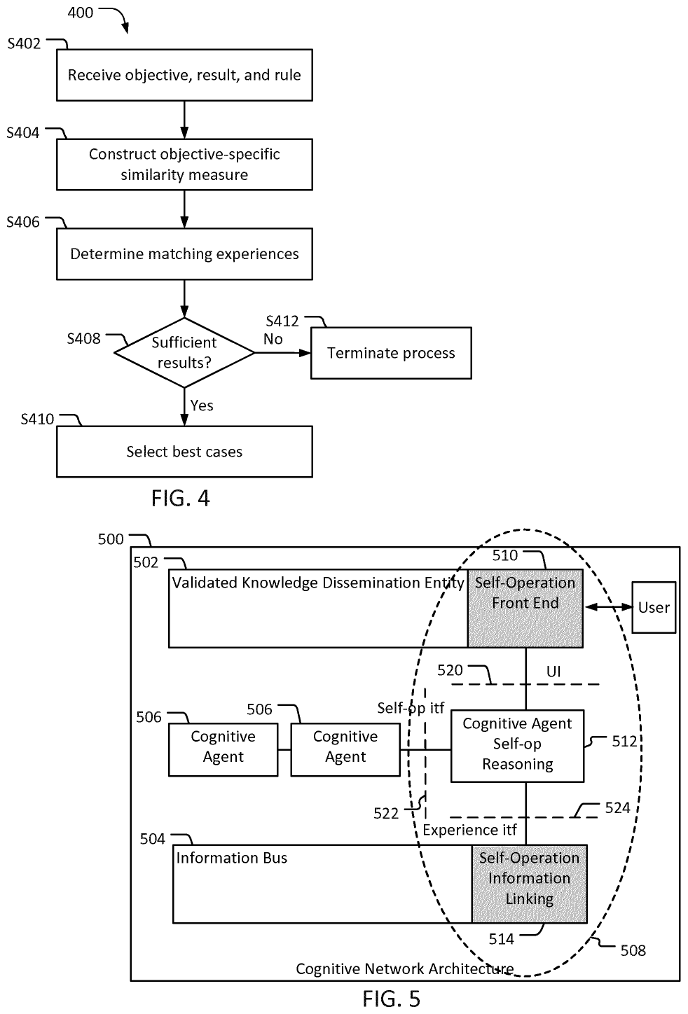

FIG. 4 shows an embodiment of a process 400 for finding a best matching function and corresponding experience cases to achieve an operator's objective. An operator provides a specific operational objective to a self-operation server at S402. The objective is accompanied by an allowed result and a rule.

The self-operation server receives the operational objective and the rule, and constructs a corresponding objective-specific similarity measure instance with information of the operational objective and rule at S404. An ID is assigned to the similarity measure, and the similarity measure may be stored in a memory.

The objective-specific similarity measure instance is then used to search for all matching operation experience cases at S406. The server determines whether there are sufficient matching cases at S408, and if sufficient cases are not found, the process terminates at S412. In addition, a message 318 that no action was found may be transmitted to an operator.

The sufficiency of results at S408 may be determined in a number of ways. In one embodiment, a number of corresponding results is compared to a threshold value, which may be as low as 1, and if the threshold value is not met, then insufficient results are present.

If sufficient matching cases are found at S406, the self-operation server automatically selects the best suitable experience cases according to the objectives and rules at S410. The self-operation server may then invoke the function-specific similarity measure by extracting pre-configured function specific attributes of one or more best suitable experience cases.

Information elements that may be included in a function-specific similarity measure include a set of general similarity attributes and function-specific attributes, as shown in Table 1 below. In an embodiment, the function-specific attributes are explicitly defined for the specific selected function, and a function-specific similarity measure instance is operation specific. In Table 1, the first two elements are general, and the remaining attributes are function-specific. Table 1 is an example provided to promote a more thorough understanding of the disclosure. Other embodiments are possible.

TABLE 1

| Element | Contents |
|---|---|
| Function-specific | A character string that uniquely identifies a |
| Similarity Measure | similarity measure instance. |
| ID | |
| Similarity Scope | The type of the managed objects (MOs) that relate |
| | to this similarity measure instance. For example, |
| | similarity scope can be one type of {individual |
| | cell, cell pair, first-tier neighbor cells, second- |
| | tier neighbor cells, subnetwork, network, etc.}. |
| | A similarity scope may be specific to a function. |
| | For example, a CCO-SURROUNDED function is |
| | optimizing the coverage performance of the given |
| | cells. Thus, the similarity scope for this |
| | function may be the given cell and its 1st-tier |
| | neighbors of the same type. |
| Function ID | The unique ID of a function (e.g., CCO- |
| | SURROUNDED) that is selected as the most |
| | relevant function to pursue the requested |
| | operation. |
| Function | The first feature specific attribute and value |
| Specific | that is automatically extracted from the selected |
| Attribute 1 | experience cases. An attribute and its value may |
| | only be extracted when this attribute impacts |
| | the function or is impacted by the output of the |
| | function. The attribute may be identified according |
| | to the scope of its impact on the function. |
| Function | The n^{th} feature specific attribute and value that |
| Specific | is automatically extracted from the selected |
| Attribute n | experience cases, where n ≥ 0 and, n = 0 |
| | means there is no feature specific attribute for |
| | the specific similarity measure instance. |

After the best suitable function is found by the self-operation server, a function specific similarity measure may have two parts. With the information of the function (e.g., CCO-SURROUNDED) and the objective-specific similarity measure (e.g., coverage-related optimization of particular cells), the self-operation server can define the first part of the corresponding function specific similarity measure. Here, information of functions in the network may be pre-defined and made available in the form of function metadata by the operator or its vendor. The function information also defines the impacting scope of the function.

The first part of the function-specific similarity measure includes static information of the function and MOs that are either pre-defined or available beforehand. This part may be generated by extracting information of the function, the corresponding cells, and the relevant rule.

For example, the first part of a CCO-SURROUNDED-specific similarity measure can include information elements and their values of such as CCO ID, cell technology, cell type, and antenna mode. For simplicity, this example assumes that the target scope has only one similarity scope. If multiple similarity scopes exist in a given target scope, their corresponding function-specific similarity measures may be defined individually using a similar approach.

The self-operation server then uses the defined first part of the function-specific similarity measure to further select matching operation experience cases from all cases still fulfilling the search criteria. For example, if there are a first number of self-operation cases found under the selected CCO-SURROUNDED function, only some portion of that number of self-operation cases may match the defined first part of the CCO-specific similarity measure.

The self-operation server extracts information of the matching cases. The particular data to extract depends on the given rule or otherwise a default configuration. For example, an extraction can be performed from all performance metrics information elements and their value ranges shared by some or all of the matching cases. These performance metrics may be, for example, the impacting and impacted metrics of RLF INPUT and RLF OUTPUT. The extracted result serves and becomes part of the similarity measure.

In the example, with the defined function-specific similarity measure, the self-operation server finds, e.g., 9 self-operation cases out of 25 cases matching the similarity measure. The configuration values (SCVs) of the 9 self-operation cases are collected into a configuration set. The self-operation server then uses one or more extracted configuration value to configure the CCO-SURROUNDED function and activate it to achieve the given objective.

A self-operation system identifies data relevant to a problem when it appears and collects the data into a set of operational experiences. A self-operation system can then apply the operational experiences when solving future problems. A self-operation system may have two distinct portions—an experience-learning part, and an experience-applying part.

The experience-learning part of self-operation may link relevant data to a trigger to compose operational knowledge, or a self-operation case. For example, relevant data such as PM data, anomalies and cell context data may be linked to a trigger such as a Configuration Management (CM) operation to form a self-operation case. The experience learning part may store and manage operational knowledge as self-operation cases.

Meanwhile, the experience-applying part of a self-operation system may interact with human and/or automated entities of a network and Operations and Management (OAM) to answer queries related to operational experiences. The experience applying part may detect a trigger by extracting the information in a request from e.g., one of those entities; generate a corresponding similarity query to find the historical similar operational knowledge for the given trigger; and use results of queries to provide recommendations.

One such recommendation is an optimum configuration operation for achieving a given high-level goal. Other possible recommendations are a recommendation to perform a specific configuration in view of past data, and one or more configuration operations that may have caused an anomaly.

Cognitive networks according to embodiments of this disclosure may use an information bus to distribute information to cognitive client applications, or cognitive agents, including network management functions. Meanwhile, knowledge may be exchanged between cognitive applications on a knowledge dissemination layer that uses high-level concepts rather than low-level data.

### Applying Experiences Across Different Information Domains

Network experiences are specific to wireless technologies, e.g. GSM, UMTS and LTE. Information that is specific to each technology may be stored in a separate information domain. Thus, a particular information domain corresponds to a particular technology.

When self-operation has no corresponding operational experiences in one information domain, it may have equivalents or closely associated operational experiences in other information domains. For example, a self-operation server may store a significant number of operational experiences concerning the operations of current LTE networks. However, the self-operation server may not have 5G-specific experiences when activating 5G technologies in a network. Here, 5G refers to one or more fifth generation technology established by the Third Generation Partnership Project (3GPP).

This disclosure provides a solution to such situations. In an embodiment, LTE-specific operational experiences are used to provide recommendations for 5G operation situations. Embodiments of the present disclosure map operational experiences across different information domains.

FIG. 5 shows an embodiment of self-operation in a virtualized cognitive agent architecture 500 that can map experiences across multiple domains. The cognitive architecture 500 includes three logical entities: a self-operation front end 510, a self-operation reasoning cognitive agent or entity 512, and a self-information linking entity 514. Three logical interfaces are shown: a self-operation UI 520, a self-operation interface 522, and a self-operation experiences interface 524. A self-operation UI entity is included in a part of the front end 510.

Although the architecture shows logical relationships between separate network entities of the cognitive network architecture 500, persons of skill in the art will recognize that the separations are not necessarily representative of separate hardware. The entities of FIG. 5 may be implemented in one or more network computing entities 200, which may be centralized or distributed throughout a network.

The self-operation front end 510 is responsible for interactions with a human user for self-operation related issues, and with the reasoning capability accessed via validated knowledge dissemination entity 502.

The self-operation reasoning entity 512 may include both of the experience-applying and learning parts of self-operation discussed above. The reasoning entity 512 makes decisions based on similar operational experiences, and provides instructions through interactions with other cognitive agents 506, as well as self-operation front end 510. The reasoning entity 512 also identifies the data relevant to a trigger, instructs the self-operation information linking entity 514 to collect the data, and then learns the collected data as a part of operational experiences for a self-operation case.

The self-operation information linking entity 514 corresponds to a section of the experience-learning part of self-operation discussed above. The self-operation information linking entity 514 is responsible for collecting and reporting information specific to a self-operation case, as requested by self-operation reasoning entity 512. In a specific embodiment, the self-operation information linking entity 514 collects the identified data or instructs another part of information bus entity 504 to collect the identified data relevant to the trigger, and reports them back to self-operation reasoning entity 512 when ready.

In an embodiment, the self-operation reasoning entity 512 instructs self-operation linking entity 514 to collect specific information attributes and their values. The self-operation linking entity 514 reports collected information attributes and their values when ready to the self-operation reasoning entity 512. In an embodiment, self-operation cases are stored by self-operation reasoning entity 512.

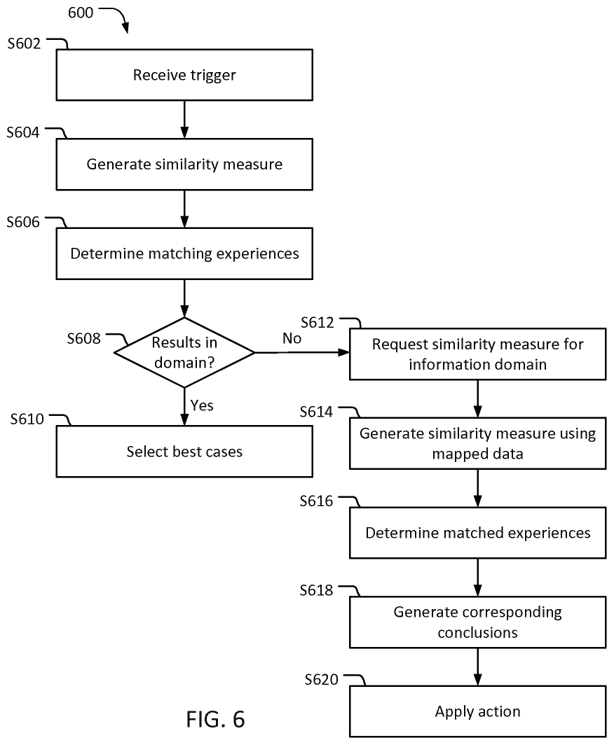

FIG. 6 shows an embodiment of a process 600 for applying self-operation in multiple information domains. Process 600 is similar to process 400. One difference between these processes is that when sufficient results are not found in one information domain, process 600 uses learned data in other information domains, and may recommend an action for a first information domain based on data of a second information domain. The information domains may be specific to particular cellular communication technologies. Another difference between process 600 and process 400 is that process 600 includes a number of operations that may be performed when insufficient results are present, including requesting a similarity measure from a validated knowledge dissemination entity at S612.

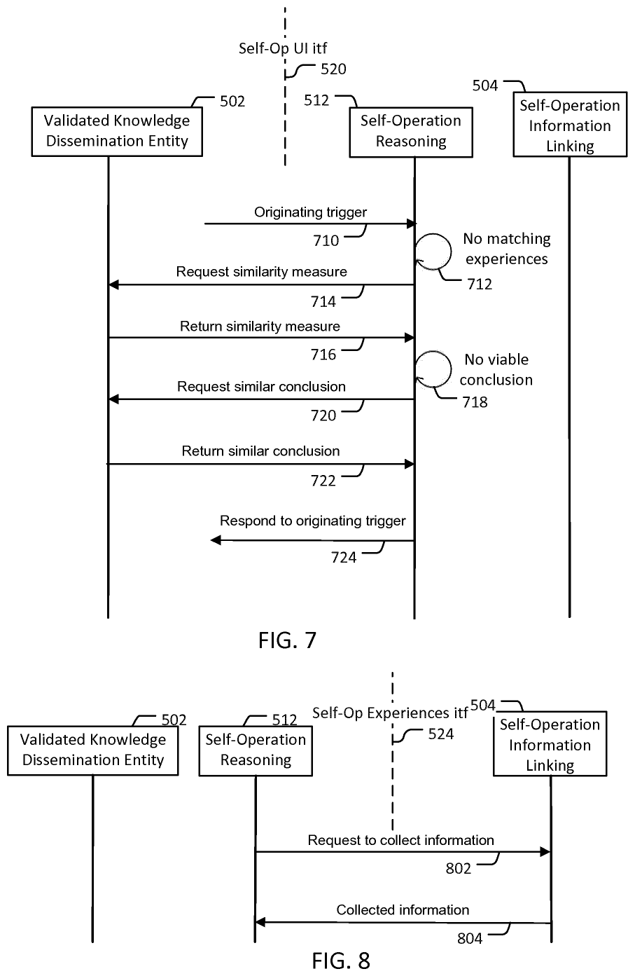

FIG. 7 is a diagram of process 600 for applying self-operation in multiple information domains according to an embodiment. Elements of FIG. 7 correspond to elements of FIG. 6 and FIG. 5.

An event trigger 710 is received at S602. The trigger may be an action request which may include, for example, a function ID, an instance ID, context, and an event. The event may be an event such as a performance value passing below a threshold, an anomaly in the network that the operator would like to resolve, or a high-level goal to be achieved for a particular network area. Examples of other events that may trigger process 600 include an indication of a status of a network, including an indication of a status of an OSS, a search query, and the action request. The event relates to information in the first domain that can be matched to network experiences.

The context relates to the event, and may include network information, equipment, etc. that relate to the event. For example, the context for an event that affects a particular cell may include parameters of that cell, such as azimuth, transmit power, capacity limits, and other values. When other cells are implicated by the event, data of the other cells may be included in the context as well. The context may be capacity or interference limited, or be limited to an impact area of a SON function.

A similarity measure is generated at S604. In an embodiment, the self-operation reasoning entity 512 generates a similarity measure query 714 that is specific to a trigger in its originating information domain, and a database of self-operation cases is searched to determine matching experiences at S606. In a specific example of actions performed by the self-operation reasoning entity 512 when it receives a trigger, consider a case in which the trigger that indicates that an RLF rate exceeds a threshold value for cells x, y and z. Here, self-operation reasoning entity 512 extracts data relevant to the trigger instance such as cell types, technology used by the cells, antenna configuration (TXP, tilt, and mode), traffic pattern, etc., of cells x, y and z and their neighbor cells. While some of this data, such as cell identities, may be included in the trigger, other data may be extracted by the self-operation reasoning entity 512 based on data in the trigger.

If sufficient results are identified in the information domain of the technology associated with the original action request, then best cases are selected at S610, and an action recommendation is returned. On the other hand, if the self-operation linking entity 504 does not identify sufficient results in the information domain of the technology associated with the original action request as indicated at 712, then the process looks to other information domains to find matching cases at S612.

A similarity measure for the information domain is requested at S612 by transmitting a similarity query request 714 from the self-operation reasoning entity 512 to the validated knowledge dissemination entity 502. The validated knowledge dissemination entity 502 then generates a similarity measure at S604 using data that maps one information domain to one or more other information domains.

In particular, self-operation reasoning entity 512 makes a request to validated knowledge dissemination entity 502 to generate a corresponding similarity measure in one or more other relevant information domain that are conceptually equivalent or close to the specific similarity measure defined in the originating information domain. For example, if the initial triggering action request 710 is for 5G, but no matching experiences are found for 5G at 712, an embodiment may generate a similarity measure for 5G based on mapping between 5G and one or more other technology, such as LTE and 3G.

The validated knowledge retained by validated knowledge dissemination entity 502 includes mapping of network information between two or more information domains, or technologies. The data that is mapped and retained by the validated knowledge dissemination entity 502 may include, for example, correlations between high-level KPIs. Such correlations may in turn be correlated to knowledge for cellular coverage and coverage functions, including transmit power, azimuth, and other antenna settings, which may be retained by an entity of system 500. The data may also include mobility data, such as selection and reselection parameters for mobility operations, idle mobility data, traffic steering data, etc.

The information domain mapping data retained by validated knowledge dissemination entity 502 may be data that has been tested and verified to be accurate. For example, the mapping data may be data from testing conducted by manual or automated processes that compare the effects of particular parameter changes in a first information domain to similar parameter changes in a second information domain. In another example, the mapping data is generated by using reasoning and concept models describing each RAT together with correlations to infer equivalences between RATs. The mapping data may be between two specific parameters, and it may include more complex parametric mapping between the effects of a plurality of parameters. Although the mapping data may be generated by machine learning processes, the data from such processes may be verified by humans before being stored by the validated knowledge dissemination entity 502.

The validated knowledge dissemination entity 502 generates one or more corresponding similarity measure in one or more relevant information domain at S614, and transmits one or more similarity measure to self-operation reasoning entity 512 in reply 716. The self-operation reasoning entity 512 searches its self-operation database with the one or more similarity measure in other relevant information domain from response 716, and determines matching experiences in the one or more other information domain at S616.

Corresponding conclusions are generated at S618 by analyzing the matching experiences, and generating one or more conclusion from the matching experiences under their corresponding information domains. In an embodiment, the self-operation reasoning entity 512 transmits a request to generate conclusions to self-operation information linking entity 504 to generate the conclusions, which may be actions that satisfy one or more objective specified in originating trigger 710. The conclusions may include one or more action to performed in the network to obtain an objective specified in the originating trigger 710.

However, as indicated at 718, the conclusions may not be viable. In particular, the reasoning entity 512 may not be able to apply the actions because the actions may be specific to a different information domain than the information domain of the action request. For example, when the trigger 710 is for a first information domain and insufficient experiences are present for the first information domain, a similarity measure is generated by the knowledge dissemination entity 502 for a second information domain based on mapping between the information domains. However, the conclusion, or actions to be taken, may be specific to the second information domain. In other words, the action may be to adjust a parameter that is present in the second information domain, but not the first information domain to which the action is intended to be applied.

In this case, the self-operation reasoning entity 512 may transmit a request 720 for a similar conclusion to validated knowledge dissemination entity 502, which may retain mapping of conclusions between various information domains. The dissemination entity 502 finds a similar conclusion and transmits the conclusion in response 722. In this example, the reasoning entity 512 has a conclusion that is appropriate to the information domain of the originating trigger 710, and responds to the trigger with the relevant conclusion at 724. The network then performs one or more action, such as changing a transmit power or pointing direction, from the conclusion to achieve the objectives specified in the originating trigger at S620. In addition, the network may learn from process 600 by updating experiences and corresponding conclusions for the first information domain.

In an embodiment, a conclusion transmitted at 724 is an analytical result corresponding to originating trigger 710, which may be, for example, an action request, an indication of an anomaly, state, or relevant occurrence in the network, an operational intention such as an objective, and an information query regarding the network and its operations. Thus, in various embodiments, a conclusion 724 may include an instruction to allow or deny an action request; a recommendation for an action, or to not take an action, in response to the indication of an anomaly, state or relevant occurrence; a recommendation for an action or other data to achieve the objective; and information extracted from the self-operation system responding to a query trigger. Accordingly, response 724 may be any number of responses depending on the contents of the originating trigger 710, and may be generally referred to as a conclusion.

To promote a more thorough understanding of embodiments of the present disclosure, the following pseudo-code is provided. The pseudo-code illustrates how specific embodiments may be implemented, and should not be construed as limiting.

In an embodiment, as seen in FIG. 8, in order to identify matching experiences, the self-operation reasoning entity 512 sends the self-operation information linking entity the following message 802:

collectInfo (sn_{I},^{1..}*( infoDomain, attributeName, collectionRange))
sn_{I} = the unique sequence number identifying info collection request and response
infoDomain = 3G | LTE | 5G | <any subdomain of them>

// it is the ID of the info domain interested by self-operation reasoning entity,
// where the whole set of the info domain IDs are predefined and known
// under the cognitive architecture.

attributeName = identity of an interested attribute
collectionRange = (startTime, endTime, manner) | (startTime, numberOfValues, manner) |

(numberOfValues, endTime, manner)

manner = allAvailabe | statisticsOf | any Rule

In response, the self-operation information linking entity 504 sends self-operation reasoning entity 512 the following message 804:

infoCollected (sn_{I},^{1..}*( infoDomain, attributeName, *(attributeValue,
timeTag)))
attributeValue = a collected value of the attribute
timeTag = the time that the attribute value is measured / collected

Similarly, the following pseudocode illustrates an example of message 714 transmitted from self-operation reasoning entity 512 to validated knowledge dissemination entity 502 over self-operation UI interface 520:

generateSimilarityQuery (snᵤ, infoDomain, similarityMeasure)
snᵤ = the unique sequence number identifying info similarity / conclusion generating request
and response

| | |
|---|---|
| similarityMeasure =string | // the similarity measure defined for the trigger under the |
| | //(originating) infoDomain |

generateSimilarConclusion (snᵤ, ^{1 ..} * (infoDomain, conclusion))

| | |
|---|---|
| conclusion = string | // the conclusion reached according to the matching |
| | // experiences under the (other) infoDomain |

An example of the contents of response message 716 is shown in the following pseudocode:

similarityQueryGenerated (snᵤ, ^{1 ..}*(infoDomain, similarityMeasure))

// the similarity measure of the (other) domain

similarConclusionGenerated (snᵤ, *conclusion)

| | |
|---|---|
| | // 0≥ conclusion generated for the (originating) infoDomain |
| z | z |

Embodiments of this disclosure provide numerous advantages to conventional wireless communications technologies. Cognitive functions improve the performance of network operations while reducing the cost, time, and error rates of improvements compared to manual or set rule-based processes. Moreover, embodiments of the present disclosure improve cognitive network processes by extending knowledge of cognitive agents for certain information domains across other information domains.

1. A method for a communications network, the method comprising:
receiving an event trigger for a first information domain specific to a first communications technology;
searching stored experience data for an experience that matches network data associated with the event trigger in the first information domain;
when no similar experiences are found in the first information domain, generating a similarity measure for the second information domain using mapping data that maps parameters of one or more managed object in the first information domain to parameters of the one or more managed object in the second information domain;
determining at least one operational experience that matches the similarity measure for the second information domain; and
responding to the event trigger with at least one conclusion based on the at least one operational experience.

2. The method of claim 1, wherein the at least one conclusion is an action for the first domain.

3. The method of claim 2, wherein the action is chosen from adjusting a transmit power of a cell, adjusting an azimuth of a cell antenna, adjusting a cell selection parameter, and adjusting a cell reselection parameter.

4. The method of claim 3, further comprising:
performing the action for one or more cell.

5. The method of claim 1, wherein the first domain is 5G.

6. The method of claim 4, wherein the second domain is GSM, UMTS or LTE.

7. The method of claim 1, further comprising:
before determining the at least one conclusion in the first information domain, determining at least one conclusion in the second information domain; and
comparing the at least one conclusion in the second information domain to second mapping data that maps conclusions in the second information domain to conclusions in the first information domain,
wherein the at least one conclusion in the first domain is a result of the comparing.

8. The method of claim 1, wherein the similarity measure comprises at least one attribute that is specific to a network management function and a list of manage objects (MOs) on which the network management function is to be executed.

9. The method of claim 1, wherein the event trigger is an action request that includes a network performance objective, and the conclusion indicates a change to a network parameter to achieve the network performance objective.

10. The method of claim 1, wherein the receiving, searching, determining and responding is performed by one or more cognitive computing entity in an Operations Support System (OSS) layer of a cellular network.

11. A wireless communication system comprising:
one or more processor;
a memory; and
one or more non-transitory computer readable medium which, when executed by the one or more processor, perform the following operations:
searching stored experience data for an experience that matches network data associated with the event trigger in the first information domain;
when no similar experiences are found in the first information domain, generating a similarity measure for the second information domain using mapping data that maps parameters of one or more managed object in the first information domain to parameters of the one or more managed object in the second information domain;
determining at least one operational experience that matches the similarity measure for the second information domain; and
responding to the event trigger with at least one conclusion based on the at least one operational experience.

12. The system of claim 11, wherein the at least one conclusion is an action for the first domain.

13. The system of claim 12, wherein the action is chosen from adjusting a transmit power of a cell, adjusting an azimuth of a cell antenna, adjusting a cell selection parameter, and adjusting a cell reselection parameter.

14. The system of claim 13, wherein at least one cell performs the action.

15. The system of claim 1, wherein the first domain is 5G.

16. The system of claim 4, wherein the second domain is GSM, UMTS or LTE.

17. The system of claim 1, wherein the operations further comprise:
before determining the at least one conclusion in the first information domain, determining at least one conclusion in the second information domain; and
comparing the at least one conclusion in the second information domain to second mapping data that maps conclusions in the second information domain to conclusions in the first information domain,
wherein the at least one conclusion in the first domain is a result of the comparing.

18. The system of claim 1, wherein the similarity measure comprises at least one attribute that is specific to a network management function and a list of manage objects (MOs) on which the network management function is to be executed.

19. The system of claim 1, wherein the event trigger is an action request that includes a network performance objective, and the conclusion indicates a change to a network parameter to achieve the network performance objective.

20. The system of claim 1, wherein the one or more processor is included in one or more cognitive computing entity in an Operations Support System (OSS) layer of a cellular network.
